(19) United States
(12) Patent Application Publication
(10) Pub. No.: US 2009/0089025 A1
(43) Pub. Date: Apr. 2, 2009

(54) Internal feature determination from field interactions in a complex medium

(75) Inventor: Timothy Edwin Doyle, Pleasant View, UT (US)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(73) Assignee: Utah State University

(21) Appl. No.: 11/906,489

(22) Filed: Oct. 1, 2007

(51) Int. Cl. G06G 7/48

(52) U.S. Cl. 703/5

(57) ABSTRACT

A method and system is disclosed for determining the internal structure and constituent properties of complexly structured materials using a computational simulation engine to calculate field propagation properties, physical testing of the materials to obtain measured field properties, and correlation of the calculated and measured field properties. The complexly structured materials consist of particles, inclusions, or voids of arbitrary distributions and compositions suspended in a matrix. The particles or inclusions can additionally display substructure such as layers or embedded subparticles, sub-inclusions, or voids. The simulation engine calculates multiple scattering in simulated materials using a multipole expansion method, and is used to generate a look-up table of propagation properties for a range of probable structures and compositions. The measurements are then classified with respect to the look-up table. The simulation results that most closely fit the test measurements provide an assessment of the internal structure and constituent properties of the material. Examples of fields that are applicable to this method and system include but are not limited to acoustic, ultrasonic, shear, seismic, and electromagnetic fields.

### TECHNICAL FIELD

This present invention relates to methods and devices for determining physical properties of materials including living tissues.

### BACKGROUND

Determining the microscopic structure and constituent properties of materials comprised of particles or inclusions suspended in a matrix (i.e., a dispersion) has many applications, including but not limited to the nondestructive evaluation of particulate composites; the inspection of structural materials such as concrete and asphalt; quality and process control of foods and pharmaceuticals; the characterization of biological tissues; the remote sensing of clouds, bodies of water, ocean sediments, and soils; and the geophysical exploration of the Earth's crust. The objectives of such determinations may be to ascertain the homogeneity, particle size, and particle distribution in the probed materials (quality control of manufactured materials); measure whether any microstructural or microcompositional changes have occurred over time (disease in tissues, damage and deterioration to composites); manage natural resources (water and soil monitoring); and discover new resources (gas, oil, and mineral exploration).

Fields of various forms are used to interrogate dispersions since many of the above applications require noninvasive, nondestructive, or remote sensing measurements. Predicting the microscopic structure and constituent properties of dispersions from field measurements is challenging, however, due to multiple scattering, heterogeneous particle sizes and compositions, heterogeneous microstructures (particle configurations), and mode conversion (for ultrasonic waves in elastic and viscoelastic solids). Analytical models have been developed to predict acoustic, ultrasonic, and electromagnetic scattering in dispersions. However, these models typically address uniform distributions of scatterers and use simple approximations such as single scattering, weak scattering (Born approximation), and fluid-like tissue properties (no ultrasonic shear waves). They are therefore accurate for primarily sparse, homogeneous distributions of identical scatterers. Additional complexity arises when the particles or inclusions have substructure (i.e., they are not uniform), or the microstructure has larger structural features that will influence the field interactions such as layers, clusters, or cavities in the particle distribution. These hierarchical materials include many natural media such as biological materials and soils. Hierarchical materials are also being developed and applied in engineering due to superior or multifunctional capabilities.

In addition to analytical approximations, empirical and statistical models have been derived from measurements on dispersions. Again, these models are most accurate for simple systems and microstructures, and cannot address complex microstructures that display large spatial variations in structure and composition, or have significant structural variations at multiple length scales.

Numerical methods have the ability to simulate specific microstructures and predict effective field properties, wave propagation properties, wave fields, and frequency spectra. Most numerical methods are too computationally intensive, however, for the simulation of large, three-dimensional particle configurations with random or complex microstructures. An exception are multipole expansion methods, which are computationally more efficient than other numerical approaches for modeling scattering from spheres, spheroids, and cylinders since they encode the field information over all space into a relatively small set of expansion coefficients. To date, multipole methods have been used mostly to calculate acoustic, ultrasonic, and electromagnetic field interactions in two-phase media containing monodisperse spheres. The iterative multipole method, however, is capable of modeling media with particles having a range of sizes and compositions. Additionally, multipole methods can be used to model layers and sub-inclusions within particles, providing a means for the simulation of hierarchical structures where the particles in a microstructure exhibit substructure.

The practical implementation of these models to the determination of physical properties and structure within materials requires the following:
1. An efficient and flexible computational method for calculating field propagation within dispersion-type materials of arbitrary microstructure and with inclusions containing substructure
2. Acquisition of minimally invasive, nondestructive, or remote physical measurements from dispersion-type materials using fields of acoustic, ultrasonic, electromagnetic, thermal, or other origin
3. A means for using the computational results to predict the material microstructure and constituent properties from the physical measurements

These steps form the basis for the invention described herein.

### SUMMARY OF THE INVENTION

A method and apparatus to determine the microscopic structure and constituent properties of a heterogeneous material with one or more dispersed phases is disclosed. The dispersed phases can be, for example, particles, inclusions, cells, or voids that may have arbitrary sizes, shapes, material properties, or positional ordering in the material; and that may additionally have substructure such as layers, voids, or sub-inclusions. A computational simulation engine is used to calculate the field propagation properties for an estimated range of material microstructures and properties, physical testing is used to measure the actual field properties, and pattern recognition is used to correlate the calculated and measured results. One embodiment of the simulation engine uses fewer assumptions, approximations, and simplifications to calculate the field properties than analytical, empirical, or other numerical methods. The method and apparatus is therefore applicable to a wide range of materials having complex microstructures (e.g., hierarchical) and provides a more accurate determination of their properties. Applications include but are not limited to the nondestructive evaluation of advanced composites, the health monitoring of concrete structures, the remote sensing of soil saturation, the process monitoring of suspensions, and the detection of microscopic cancer in the human body.

### DESCRIPTION OF THE FIGURES

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1. Saturation model for soil as an example of a complex medium, showing saturation of pores inside soil grains (a), and saturation as absorbed layers on the soil grains (b).

FIG. 2. Model for biological tissue comprised of spherical cells with embedded mitochondria, vacuoles, and nuclei.

FIG. 3. Schematic of ultrasonic scattering processes in tissues modeled with the iterative multipole approach, showing the inclusion of cell structure (nucleus+cytoplasm), tissue structure (cells+extracellular matrix), and multiple scattering.

FIG. 4. (A) Three-dimensional depiction of a random cluster of 327 cells with a 50% volume density in an extracellular matrix. (B) Two-dimensional slice through the cell cluster. The cells and nuclei are 20 μm and 10 μm in diameter respectively. (C) Scattered+incident wave field displacements from an incident 10-MHz longitudinal wave. (D) Scattered wave field displacements only. Incident wave propagation is from left to right.

FIG. 5. Examples of hierarchical tissue structures simulated with the iterative multipole approach consisting of randomly distributed cavities in a random tissue. Decreasing cavity size represents infiltration of malignant cancer cells with larger nuclei (nuclear pleomorphism) with 0% (A), 58% (B), 76% (C), and 100% (D) infiltration. Simulated tissue is a cylinder 280 μm long by 280 μm in diameter and consisting of 1049 to 2075 cells.

FIG. 6. Simulated ultrasonic frequency spectra for random tissues containing up to 2075 cells with (A) the nucleus diameter varied uniformly for all of the cells, and (B) infiltration of malignant cells with larger nuclei than the surrounding tissue (see FIG. 5). Both sets of spectra correspond to tissue changes associated with cancer. Each spectrum is averaged from simulations of five tissue configurations having the same general complex structure but with specific cell and cavity locations varied.

FIG. 7. (A) Two-dimensional slice through a simulated three-dimensional tissue of 1642 cells in a collagen matrix. Cells and nuclei are 20 and 8 μm in diameter respectively. (B) Electric field amplitude at 10 GHz, showing strong field gradients across cell membranes. (C) Electric field amplitude with cell membrane fields suppressed in image.

FIG. 8. Smooth muscle tissue (left) and prolate spheroid cell model (right) for modeling field propagation.

FIG. 9. Spheroidal model of papillary epithelial tissue containing columnar cells and smooth muscle stroma.

FIG. 10. Flow diagram of calculation steps performed in the simulation computation engine.

FIG. 11. Bistatic (through-transmission) measurement setup for the characterization of a material sample with ultrasonic waves. For this drawing, the digitizer is shown as a digitizing oscilloscope.

FIG. 12. Block diagram showing how the simulation computation engine (iterative multipole program) would be used to determine the microstructure and/or constituent material properties of a measured material (including living tissues).

FIG. 13. Ultrasonic intensity trends at 23.5 and 47 MHz for variation in nucleus size (A) and percent infiltration into tissue cavities (B), corresponding to the spectra shown in FIGS. 6A and 6B respectively. Spectra were averaged from simulations of five tissue structures where the cell and cavity locations were varied, providing five test cases for each nucleus size or percent infiltration. The error bars are the standard deviations.

### DETAILED DESCRIPTION OF THE INVENTION

The following detailed description of exemplary embodiments of the invention makes reference to the accompanying drawings, which form a part hereof and in which are shown, by way of illustration, exemplary embodiments in which the invention may be practiced The elements and features of the invention are designated by numerals throughout. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

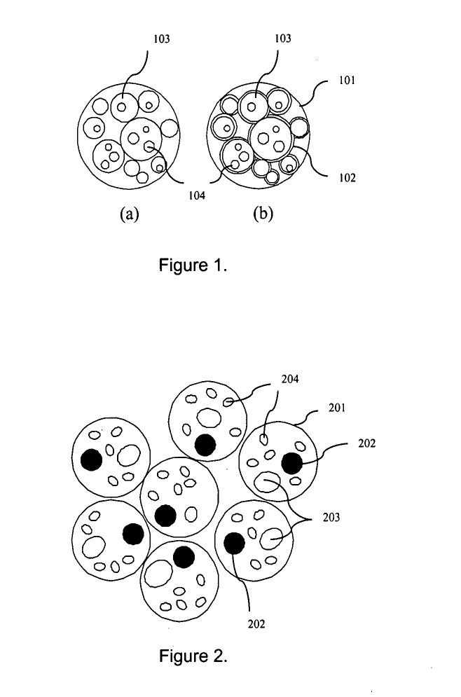

This method provides a measurement of material properties by probing the material 1110 with a field 1111 and analyzing transmitted or reflected signals with a model-based computation of the propagation. A field is defined as a physical interaction that is extended through space (for example, gravity, electricity, or magnetism). Fields can either be static/unchanging in time (e.g., mechanical stress fields, electric fields, magnetic fields) or dynamic/changing in time (e.g., waves, pulses, etc.). Embodiments include acoustic, elastic, or electromagnetic fields in a complex medium comprised of particles 103 or inclusions embedded in a matrix 101. The particles or inclusions can be in an ordered, disordered, or complexly ordered arrangement. The particles or inclusions additionally may have an internal structure that may include layers 102, 201, particles 202, inclusions 203, or voids 104. Illustrative but not limiting examples of media that can be modeled based on these complex structures include partially saturated soils (FIG. 1) and biological tissue (FIGS. 2-9).

The larger particles or inclusions embedded in the matrix will be referred to as “primary bodies”. They represent, for example, the cells in tissues 201 or the grains in soil 103. The smaller particles, inclusions, or voids embedded within the primary bodies will be referred to as “secondary bodies”. They represent, for example, the organelles in the cells 202, 204. or the voids in the soil grains 104. The computational method uses in one embodiment vector multipole expansions to model the acoustic, elastic, or electromagnetic fields that are incident upon, refracted internally, and scattered externally by the primary and secondary bodies. Both the primary and secondary bodies are therefore modeled with symmetric shapes for which vector multipole expansions exist such as spheres, spheroids, or cylinders.

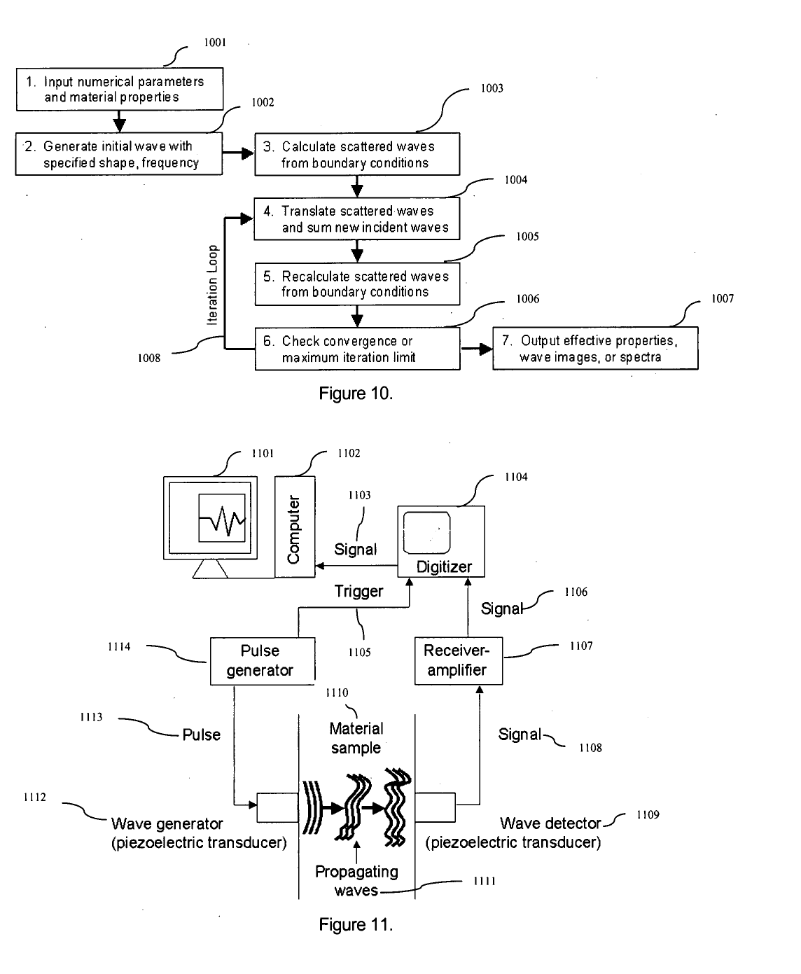

One embodiment of the computation process is shown schematically in FIG. 10 and is as follows:
1. The medium to be simulated is input, including the coordinates, sizes, and properties of the primary and secondary bodies 1001. The matrix properties are also input, as well as computational parameters such as maximum multipole order to be computed and maximum number of iterations.
2. An incident field is generated in the model with vector multipole expansions to propagate through the medium 1002. This field is often a plane wave, but can also be modeled as a wave with an arbitrary wavefront (for example, a spherical wave). The frequency of the wave can also be varied to model frequency spectra or waves with a specific shape in the time domain (for example, a wave pulse).
3. The refracted and scattered fields are solved for each primary body using boundary condition solutions 1003. The interactions of the secondary bodies with the primary's refracted fields are accounted for in these solutions. If the secondary body has the same shape and coordinate origin as the primary body (e.g., concentric spheres), the secondary body interacts straightforwardly with the primary body, resulting in a linear system of equations for the boundary conditions where the field coefficients are independent with respect to multipole order. However, if the secondary body does not have the same shape and/or coordinate origin as the primary body, then the internal interactions are computed with the use of addition theorems, which translate multipole expansions from one coordinate system to another. This translation results in a larger system of linear equations since the field coefficients are no longer independent across multipole orders. In both cases, the linear system of equations is solved with standard analytical or numerical solution methods known to those skilled in the art.
4. Multiple scattering between primary bodies is simulated by translating the scattered fields from each primary body to other primary bodies with the use of addition theorems 1004. The translated fields are then summed at each primary body and added to the incident field to create a new incident field.
5. The boundary conditions for each primary body are solved as in Step 3, but using the new incident fields 1005.
6. Steps 4 and 5 are repeated iteratively until the field amplitudes converge to within a user-defined accuracy 1006.
7. The final fields are evaluated to provide field images, spectra, or effective propagation properties for the medium 1007.

Note the addition theorem computations can be replaced with other methods for translating multipole fields such as recurrence equations or numerical approaches. An example of a numerical approach is one that translates the fields point by point, and then reconstructs the multipole expansions using a matrix method similar to tomographic reconstruction.

The iterative approach for simulating multiple scattering is applicable to ordered, disordered (random), and complexly arranged systems of primary bodies. Similarly, the boundary condition solution method can accommodate a variety of internal structures such as multiple secondary bodies, multiple layers, or combinations of both. The multiple scattering interactions between primary bodies can also be made more computationally efficient with the use of nearest-neighbor approximations (where only the nearest neighbors interact), translational symmetry for ordered lattices, fast multipole methods, and similar approaches.

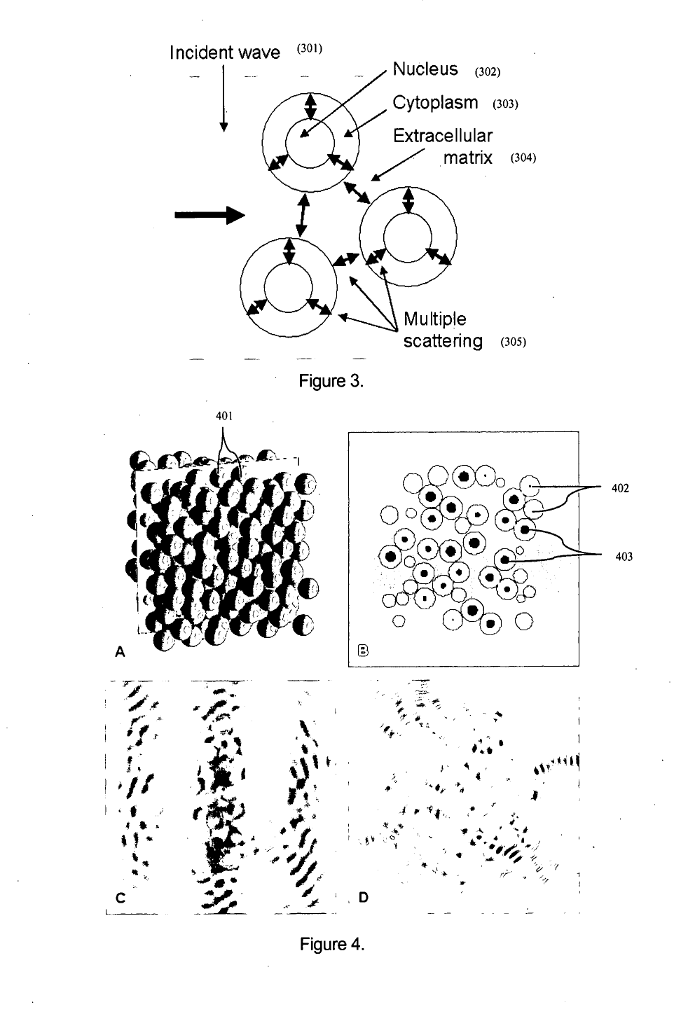

The feasibility of the disclosed computational method has been demonstrated with tissue simulations containing up to several thousand cells and using a first-order approximation for the cell structure. The cells were modeled with a concentric spherical shell-core structure embedded in a medium, with the core, shell, and medium representing the cell nucleus 302, the cell cytoplasm 303, and the extracellular matrix 304, respectively. FIGS. 3-6 display some results from these simulations for ultrasonic waves. Contrary to current scientific consensus, the results indicate that tissues do not behave acoustically at the microscopic scale as either homogeneous fluids or as a medium with simple scatterers (i.e., primary bodies with no internal structure). FIG. 7 displays results from simulations of electromagnetic fields in tissues. For these simulations, an extra layer was added to the cells to model the electrical properties of the cell membrane.

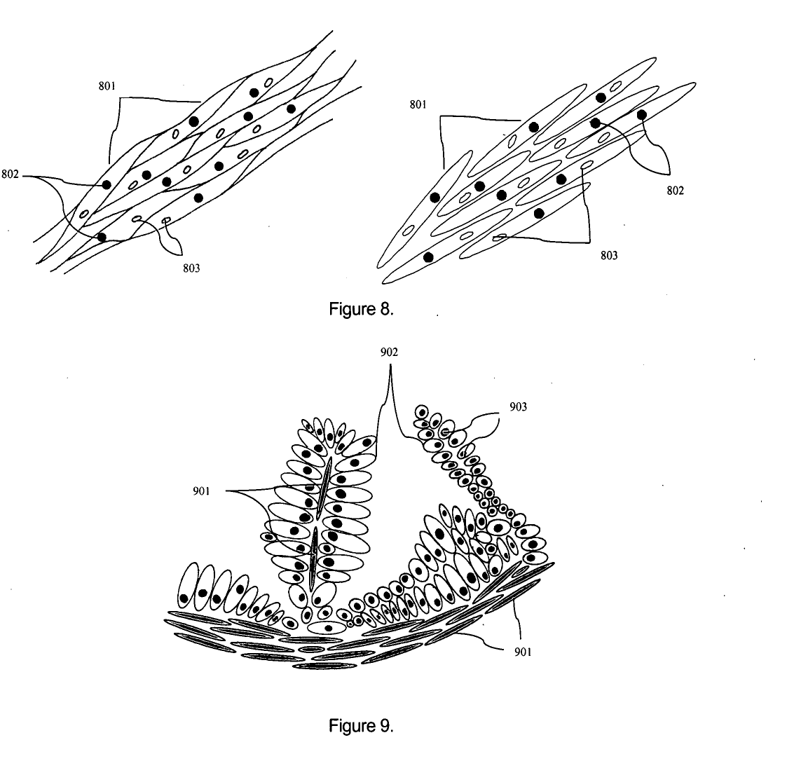

The use of spheroidal or cylindrical bodies and multipole expansions in the disclosed method will allow it to model nonspherical cell, particle, or inclusion shapes as well. For example, FIG. 8 shows how smooth muscle tissue can be represented as a collection of prolate spheroid cells 801, and FIG. 9 shows the modeling of papillary epithelial tissue.

An input field generator is used to convert an electrical signal into a field propagating into free space or a medium 1112. Input fields to probe the material can come in multiple forms, including but not limited to acoustic, shear, ultrasonic, seismic, electromagnetic, plasma, and thermal fields. Hybrid modes or means of generating fields are also possible, and for example include photo-acoustic, electro-acoustic, and thermo-acoustic fields. The characteristics of the input field can be measured during the examination process, inferred from known previous measurements of the generator, or calculated from known characteristics of the generator. The input field generator is positioned to allow for the field output to impinge on the sample of interest 1110. The input field generator may be placed in direct contact with the sample to allow direct transmission of the fields into the medium. Alternatively, a coupling medium may be used between the input field generator and sample either to protect the sample or to permit greater field transmission by functioning as an intermediary medium with transmission characteristics between those of the generator and of the sample (for example, the frequent use of acoustic-impedance matching layers and coupling gels in ultrasound).

Illustrative but not limiting examples of field generators that can be used are ultrasound generators, electromagnetic field generators or a combination of the two. The computational method described herein can calculate the scattered fields from the material using an arbitrary input field. The invention is therefore not limited to any specific generator design or field input, and is applicable to input fields with planar, spherical, cylindrical, and complex (arbitrary) forms.

Ultrasound is a form of cyclic sound pressure with a frequency greater than the upper limit of human hearing, this limit being approximately 20 kilohertz (20,000 hertz). Ultrasound is used in conventional nondestructive testing to find flaws in materials. Frequencies of 2 to 10 MHz are common but for special purposes other frequencies are used. Inspection may be manual or automated and is part of modern manufacturing processes. Most metals can be inspected as well as plastics and composites. Lower frequency ultrasound (50 kHz to 500 kHz) can also be used to inspect less dense materials such as wood, concrete and cement.

Medical ultrasound is used for diagnostic imaging of soft tissues and blood flow in the body. For clinical applications, the frequency range of medical ultrasound is typically 0.5 to 10 MHz. However, for applications such as intravascular ultrasound the frequency range can extend to 40 MHz.

Ultrasonic generators include crystal, ceramic, or polymer piezoelectric transducers 1112; electromagnetic acoustic transducers (EMATS); magnetostrictive transducers; capacitive (electrostatic) transducers; and pulsed laser generation. Except for pulsed laser generation, an electrical waveform or pulse generator is typically used to drive the transducer with a particular voltage, current, and frequency signature (square-wave pulse, spike pulse, frequency sweep, etc.).

Electromagnetic generators will vary in design based on the frequency range of operation. For low-frequency radio waves to microwaves they may include conventional dipole antennas, horn antennas, or open-ended waveguides. Terahertz wave generators include time-domain pumping with femtosecond laser pulses or two-frequency mixing of laser emissions. Electromagnetic generators for the infrared to ultraviolet light region include thermal emission sources, ionized gas line sources, semiconductor emission sources, and lasers.

Microwaves are used for the nondestructive evaluation of complex media and the sensing of soil properties, and are being researched for medical imaging. In these applications the electromagnetic generator is typically an open-ended waveguide, horn antenna, or dipole antenna. Optical methods are also being researched for medical diagnostics, and in many applications the electromagnetic generator is a laser coupled with optical fibers to transmit the waves to the tissue surface.

The output of the field input is typically but not always measured with a detector of the same design as the field generator. Examples where the detector is the same in design as the field generator include the use of piezoelectric transducers 1109 in nondestructive ultrasonic evaluation and the use of dipole antennas, horn antennas, and open waveguides in microwave testing. Examples where the detector differs in design from the field generator include the use of optical and infrared detectors for light scattering, the optical detection of ultrasonic waves (for example, with interferometers or photorefractive methods), and seismic generators and detectors. The detector is used to convert the output field energy into an electrical signal 1108, where the amplitude of the voltage or current as a function of time or space is measured.

The computational method described herein can calculate the scattered fields from the material at any location in space. The invention is therefore not limited to a specific generator-detector geometry and is applicable to all generator-detector configurations, including but not limited to those of monostatic geometries (generator and detector having the same spatial coordinates), bistatic geometries (generator and detector having different spatial coordinates), and array geometries (multiple generators and detectors with different spatial coordinates). Examples of monostatic configurations include pulse-echo ultrasonic testing, open-waveguide probes for electromagnetic soil sensing, and radar. Examples of bistatic configurations include through-transmission ultrasonic and microwave testing (for example, see FIG. 11). Examples of array methods include phased array imaging, computed tomography, reflection tomography, and optical coherence tomography.

The electrical signal from the detector may or may not be rectified and amplified by a receiver 1107. In one embodiment the signal is then digitized and recorded in digital form 1104 (for example, in random access memory, on a computer hard disk, or on optical storage media). The digital format of the signal allows the signal 1103 to be compared to the computer simulation results. The signal may also be further processed for comparison to the simulation results. This processing may include smoothing, low or high band pass filtering to remove noise or measurement artifacts, and the Fourier transformation of time-domain signals to frequency-domain spectra. Other processing and transform operations may also be performed on the signal.

FIG. 11 is a schematic of an example of a measurement system for the ultrasonic characterization of materials. Both the wave generator 1112 and wave detector 1109 are piezoelectric transducers (for example, using a lead zirconate-titanate or PZT piezoceramic). The ultrasonic pulser 1114 generates a high-voltage pulse 1113 (100-600 V) typically of a half square-wave or spike shape in the time domain. The wave generator 1112 converts this electrical signal into an ultrasonic wave pulse in the material. The wave pulse is multiply scattered in the material 1110, and the wave detector 1109 measures its output. The wave detector 1109 converts the ultrasonic pulse into an electrical signal 1108 which is amplified by a receiver 1107, digitized by a digital oscilloscope 1104 or analog-to-digital device, and stored on a computer 1102. A similar system can also be configured for microwaves, where the wave generator and detector are replaced with waveguides or antennas, and the pulse generator, receiver, and digitizer are replaced with an impedance analyzer.

To analyze the output of a field measurement, a set of material systems for the computational engine are generated, ran through the field simulations, and compared to the output. Input files define the microstructure and constituent compositions for the simulated material, and include the position (coordinates in three-dimensional space), size, and field propagation properties (elastic constants, permittivity, etc.) for each primary and secondary body. For random microstructures these files may be constructed from sphere or spheroidal packing programs using Monte Carlo or molecular dynamics numerical simulations. Ordered microstructures can be constructed using specialized algorithms that mathematically determine the positions of the primary bodies using symmetry and periodicity.

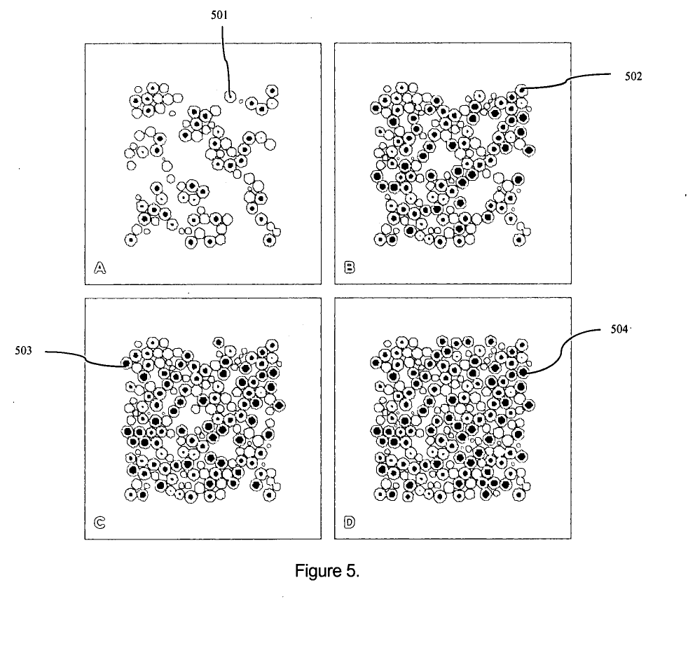

Complex hierarchical microstructures can be constructed by a superposition of two separate microstructures. For example, large random cavities superimposed on a random distribution of cells (FIG. 5) have been used to simulate high-frequency ultrasonic wave propagation in biological tissues with hierarchical structures. The primary and secondary bodies in these simulations represent cells and their nuclei respectively (FIG. 3). The cavities are analogous to structures such as lobules in breast tissue, and histological modifications to these tissue structures that correspond to neoplastic changes were modeled. FIG. 5 shows the simulated infiltration of malignant cells 504 into the tissue cavities, with both the normal and malignant cells having diameters of 20 μm. The malignant cells 504, however, were modeled with larger nuclei (14 μm) than those for the normal cells 501 (10 μm) to represent nuclear pleomorphism (enlargement of the nucleus due to cancer).

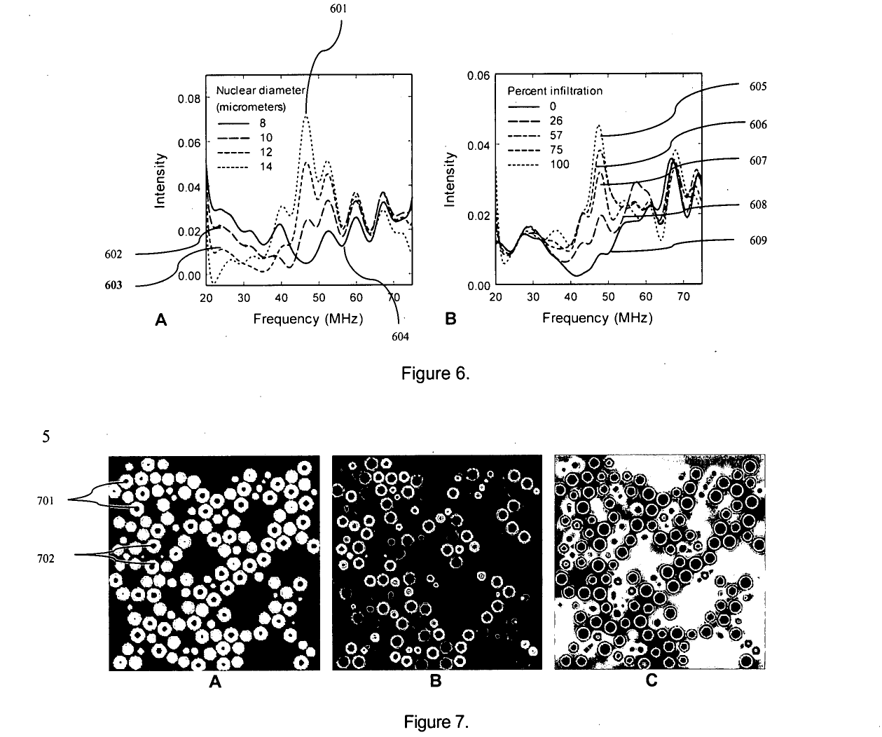

FIG. 6 displays spectra from random tissues (no cavities) where the nuclear diameters were uniformly varied (FIG. 6A), and spectra resulting from the histological changes as modeled in FIG. 5 (FIG. 6B). The random tissue spectra where the nuclear diameters were uniformly varied (FIG. 6A) exhibited substantial changes with nucleus size across a wide frequency range (20-56 MHz). Similarly, the backscatter spectra resulting from malignant cell invasion (FIG. 6B) displayed sizable amplitude changes at 47 MHz that were indicative of the degree of infiltration. These results reveal that high-frequency ultrasonic spectra may be sensitive to changes in tissue structure due to microscopic or early stage cancer, and may provide real-time histopathology (nuclear grading as in FIG. 6A and staging of microscopic infiltration as in FIG. 6B) during surgeries, biopsies, and endoscopies.

The range of material systems and physical structures that can be modeled under this invention is extensive. Examples include, but are not limited to, the differentiation between normal, benign, and malignant tissues in vivo (FIGS. 5 and 6); the detection, counting, and sizing of voids or bubbles in solids or fluids; determining the heterogeneity of a material; sensing moisture content, texture (grain size distributions), and porosity in soils (FIG. 1); measuring the particle size, composition, and total amount of a suspended component in an emulsion; monitoring composition or property changes in a material as a function of time (weathering, chemical aging, degradation); detecting matrix-particle separation (debonding) in composites (microdamage); and characterizing aerosols in the atmosphere. The computational method provides for the simulation and analysis of a broad range of physical structures since the particles or inclusions can be heterogeneous with a mixed distribution of sizes, compositions (including voids), and substructures. The particles, inclusions, or voids can additionally be arranged in any possible configuration including ordered structures, random or disordered structures, and complex or hierarchical structures.

An alternative to constructing material microstructures from a theoretical basis is to image actual material microstructures from a set of representative materials. Assembling two-dimensional image slices from optical photographs, microphotographs, or computed tomograms can render three-dimensional images of the microstructure. Computer processing can then define the microstructure numerically by providing the sizes, aspect ratios, and centroid positions for each primary and secondary body.

Once the computational parameters, microstructure, and constituent properties have been input for a simulation 1001, the computation engine generates initial fields of specified characteristics using an appropriate combination of multipole expansions 1002. The initial fields are specified to model as closely as possible the input field used for the test measurements (for example, a plane wave pulse with a Gaussian frequency distribution). The initial field is then translated to the coordinate system of each primary body (particle, inclusion, or void). Internal refracted fields and scattered fields from the primary bodies are then calculated using the boundary conditions 1003. The secondary bodies are included in the boundary condition calculations, and may or may not involve the use of addition theorems depending on whether they are concentric (i.e., share the same coordinate origin as in FIG. 3) with the primary body or not.

The scattered fields from each primary body are then translated to other primary bodies via addition theorems, recurrence equations, or numerical methods 1004. These translated fields are added to the initial field and represent the contributions from multiple scattering. The scattered fields are then recalculated 1005. This process is repeated iteratively until either the field amplitudes converge or a maximum iteration limit is reached 1006. Results from the field interactions in the simulated material are then output as field images, frequency spectra, or effective (macroscopic) properties for the material 1007.

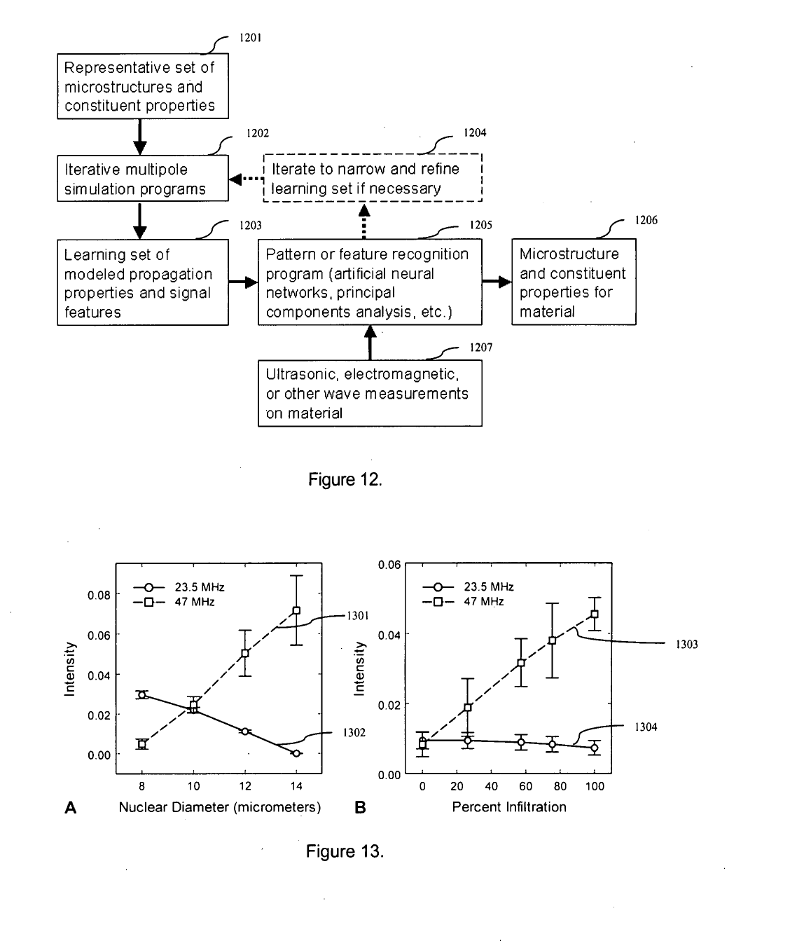

To determine the internal structure and composition of a tested material from the measured output of a field, the measured output is compared to a database or look-up table of simulation results from the computation engine (FIG. 12). The look-up table is generated for the general class of materials being evaluated, and includes a range spanning the probable compositions and microstructures for the material state based on a priori knowledge of the material's general characteristics and history. The simulations that comprise the look-up table also replicate in silico the measurement conditions as closely as possible (for example, the field spatial and frequency characteristics).

The measured field output is compared to the look-up table using a feature recognition, artificial intelligence, or other best-fit approach 1205. Examples of such approaches include, but are not limited to, principal components analysis (PCA), artificial neural networks (ANNs), and genetic algorithms. PCA of frequency spectra will be used as an example for the correlation process. Using PCA analysis, the simulated spectra are used to define a set of eigenvectors that span the group of possible spectra for the range of structures and compositions simulated. The output spectrum is then analyzed with respect to these eigenvector spectra and assigned a set of scores corresponding to the eigenvalues. The scores represent the combination of simulated structures and compositions that most closely fit the measured output. Each score is a weighting that describes how much structure and composition comprises the material.

The correlation process may also be refined in an iterative process 1204. For example, if a PCA analysis provides a set of two structures and compositions equally compatible with the output, a second set of simulations can be performed on intermediary and hybrid material systems to generate a more refined look-up table. A second PCA analysis can subsequently be performed to narrow down the set of possible structures/compositions that can be assigned to the tested material. The system therefore operates in a learning mode by gathering more highly resolved simulation results based on the output data it analyzes. It will be apparent to anyone practiced in the art how ANNs and other feature recognition approaches can be applied in the same manner.

Note that the iterative process is only necessary when a single structure/composition is not clearly dominant (i.e., it does not have a PCA score that corresponds to a specifically simulated structure/composition). The iterative process should handle most cases of ambiguity where no simulation is clearly best. However, if the correlation process with iteration cannot determine a predominant structure/composition, then a disparity should be expected between the measurement setup and the simulation parameters (field characteristics, geometry, etc.). In this case, a validation will be required where a material of known structure and composition is measured and its output compared to the simulation. An iterative procedure is then followed similar to the correlation process, but where the simulation parameters are varied in order to find the source of the discrepancy.

Once a specific structure/composition is correlated from the look-up table to an output from a measured material, the material is assumed to have that structure/composition. The level of confidence for the prediction can be determined from the degree of correlation. For example, using PCA the degree of correlation would be proportional to the amplitude of the eigenvalues corresponding to the simulated structure/composition. Again, this correlation can be increased using the iterative refinement and learning process.

Comparison of different spectral features in FIG. 6 provides a simple illustration of how a pattern recognition program could distinguish between different types of cancer processes and associated tissue microstructures from simulation results. For example, ultrasonic simulations of both nuclear pleomorphism in homogeneous tissues (FIG. 6A) and infiltration of malignant cells into heterogeneous tissues (FIG. 6B) show significant intensity increases at 47 MHz. The 47-MHz trends are nearly linear, with coefficients of linear correlation of r=0.92 (FIG. 13A) and r=0.87 (FIG. 13B) respectively. In contrast, the spectral intensity at 23.5 MHz displays a negative correlation to nuclear diameter (FIG. 13A, r=−0.99) but is insensitive to percent infiltration (FIG. 13B, r=−0.30). These differences in spectral responses could be differentiated by a pattern recognition method, and may permit both the in vivo grading of homogeneous tissues in tumors and the in vivo staging of microscopic or micro-invasive cancer in heterogeneous tissues.

What is claimed is:

1. A method for determining properties of a material, comprising:
a simulation computation engine;
an input means to probe the material;
a measure of the output of said input means to probe the material;
a set of predictions of said simulation computation engine of said measure of output of said input means to probe the material;
comparison of said measure of output of said input means to probe the material with said set of predictions of said simulation computation engine to choose best fit of said simulation engine to said measure of said input means to probe the material; and
identifying properties of material based on said comparison.

2. The method for determining properties of material of claim 1 wherein: said input means to probe the material is ultrasound.

3. The method for determining properties of material of claim 2 wherein:
said measure of output includes a measure of amplitude over more than one ultrasound frequency.

4. The method for determining properties of material of claim 1 wherein:
said input means to probe the material is electromagnetic radiation.

5. The method for determining properties of material of claim 4 wherein:
said measure of output includes a measure of amplitude over more than one electro-magnetic radiation frequency.

6. The method for determining properties of material of claim 1 wherein:
said input means to probe the material is acoustic energy.

7. The method for determining properties of material of claim 6 wherein:
said measure of output includes a measure of amplitude over more than one frequency of acoustic energy.

8. The method of determining properties of material of claim 1 wherein:
said computation engine includes the steps of;
step 1, the medium to be simulated is input, including the coordinates, sizes, and properties of the primary and secondary bodies;
step 2, an incident field is generated in the model with multipole expansions to propagate through the medium;
step 3, the refracted and scattered fields are solved for each primary body and included secondary bodies using boundary condition solutions;
step 4, multiple scattering between primary bodies is simulated by translating the scattered fields from each primary body to other primary bodies;
step 5, the translated fields are then summed at each primary body and added to the incident field to create a new incident wave field;
step 6, the boundary conditions for each primary body and included secondary bodies are solved as in step 3, but using the new incident fields;
steps 4 and 5 are repeated iteratively until the field amplitudes converge to within a user-defined accuracy; and
the final fields are evaluated to provide physical properties.

9. The method for determining properties of material of claim 8 wherein:
said evaluated physical properties include a field images.

10. The method for determining properties of material of claim 8 wherein:
said evaluated physical properties include a spectrum.

11. The method for determining properties of material of claim 8 wherein:
said evaluated physical properties include effective propagation properties for the medium.

12. A method for determining properties of a material, comprising:
calculating a set of predictions using a simulation computation that simulates the interaction of said field input;
probing the material with a field input;
measuring of the output of said field input;
comparing said measure of output of said field input means to probe the material with said set of predictions of said simulation computation engine to choose best fit of said simulation engine to said measure of output of said input means to probe the material; and
identifying properties of material based on said comparison.

13. The method for determining properties of material of claim 12 wherein:
said input field is ultrasound.

14. The method for determining properties of material of claim 12 wherein:
said measure of the output includes a measure of amplitude over more than one ultrasound frequency.

15. The method for determining properties of material of claim 12 wherein:
said input field is electromagnetic radiation.

16. The method for determining properties of material of claim 15 wherein:
said measure of output includes a measure of amplitude over more than one electro-magnetic radiation frequency.

17. The method for determining properties of material of claim 12 wherein:
said input field is acoustic energy.

18. The method for determining properties of material of claim 17 wherein:
said measure of output includes a measure of amplitude over more than one frequency of acoustic energy.

19. An apparatus for determining properties of a material comprising:
a means for generating an input field signal producing an input field signal;
a scattered output signal resulting from said input field signal;
a means for measuring the scattered output signal resulting from said input field signal;
a means to position said material with said means for generating input signal and said means for measuring scattered output signal into a known configuration;
a means to store simulation data; and
a means to compare said output signal with said stored simulation data.

20. The apparatus of claim 19 further comprising:
a means for identifying physical properties of said material from said comparison.

21. The apparatus of claim 19, wherein:
said input field signal is ultrasound.

22. The apparatus of claim 19, wherein:
said input field signal is electromagnetic radiation.

23. The apparatus of claim 19, wherein:
said input field signal is acoustic energy.
